(19) United States
(12) Patent Application Publication
(10) Pub. No.: US 2013/0135857 A1
(43) Pub. Date: May 30, 2013

(54) LIGHT-EMITTING DIODE ROAD LAMP STRUCTURE

(71) Applicants: Chia-Chin CHEN, Tainan City (TW); Jiunn-Horng LEE, Tainan City (TW); Yu-Bin FANG, Tainan City (TW); Tzu-I TSENG, Tainan City (TW); Hung-Ta HSIAO, Tainan City (TW); Chin-Feng LIN, Tainan City (TW)

(72) Inventors: Chia-Chin CHEN, Tainan City (TW); Jiunn-Horng LEE, Tainan City (TW); Yu-Bin FANG, Tainan City (TW); Tzu-I TSENG, Tainan City (TW); Hung-Ta HSIAO, Tainan City (TW); Chin-Feng LIN, Tainan City (TW)

(21) Appl. No.: 13/306,916

(22) Filed: Nov. 29, 2011

(51) Int. Cl. F21V 1/00; F21V 21/00

(52) U.S. Cl. 362/235; 362/249.02

(57) ABSTRACT

A light-emitting diode road lamp structure includes a seat body and a plurality of tube bodies. The seat body includes an accommodation space to accommodate a circuit unit. The tube bodies are juxtaposedly connected to an outside of the seat body, a plurality of light-emitting (LED) units accommodated in the tube bodies are electrically connected to the circuit unit, and an interspace is formed between each of the tube bodies and the tube body abutted therewith, thereby providing the road lamp with a better heat-dissipation efficiency by the air flow passing through the interspace, maintaining the luminous efficiency of the LED units, and extending the life span of the LED units.

### BACKGROUND OF THE INVENTION

1. Field of the Invention

The present invention relates to a light-emitting diode road lamp structure, and in particular relates to a road lamp structure providing light-emitting units dispersedly and juxtaposedly disposed outside a seat body and forming interspaces to allow the air flow passing there through to efficiently perform heat dissipation.

2. Description of the Related Art

In general, light-emitting diode (LED) lamp tubes are capable of conserving 60% to 70% of electricity without mercury vapor pollution, compared to fluorescent tubes. In view of the trend in the word on energy conservation and environmental protection issues, the fluorescent tubes are gradually replaced by the LED lamp tubes. However, in the process of electro-light conversion of the LED, there still has about 60% to 80% of electrical energy incapable of being converted into visible light, but this 60% to 80% of electrical energy is presented in the form of heat instead, this to bring about the heat dissipation problems in the current LED products. When the temperature of the LED chip is high, it is possible for the LEDs to degrade the luminous efficiency, to decay the luminous flux and to reduce the life span.

Referring to FIG. 11, a relationship diagram of the junction temperature and the luminous efficiency of a light-emitting diode (LED) is presented. When the junction temperature of the LED is risen from 25° C. to 100° C., the luminous efficiency of color lights (e.g., red, yellow, blue, green and white light) of the LED has 20% to 75% degradation, wherein yellow light having the luminous efficiency of 75% degradation is the worst. Referring to FIG. 12, a relationship diagram of the operation temperature and the life span of a LED is presented. It is known that the higher the operating ambient temperature of the LED has, the less the life span of the LED is obtained. When the operating temperature of the LED is risen from 63° C. to 74° C., the average life span of the LED is averagely reduced by one third. It is understood that the influence of temperature on the performance of the LED is very important.

Taiwan New Model Patent Publication Number M358917 discloses a LED road lamp structure, corresponding to the published U.S. Pat. No. 7,909,489, including a lamp shade, a LED unit assembled below the lamp shade, and a heat-dissipation device disposed in the lamp shade. The LED road lamp structure further includes a base attached on the LED unit, a uniform-temperature plate and two heat-dissipation elements. The uniform-temperature plate includes a heating segment attached to the base, two heat-transferring segments respectively and upwardly bent and extended from two sides of the heating segment, and a condensing segment respectively and laterally bent and extended from the two heat-transferring segments. Further, each of the two heat-dissipation elements includes a heating seat and a plurality of heat-dissipation fins disposed on the heating seat. Two heating seats of the two heat-dissipation elements are attached to the outside of the two heat-transferring segments of the uniform-temperature plate. Two condensing segments of the uniform-temperature plate are attached to the inner margins of the top portion of the lamp shade.

However, in '917 case still has some technical issues required to be overcome as follows. First, because the road lamp has a box-shaped device which is not streamlined and provides a large section therein, the fluid located on the top portion of the road lamp cannot be smoothly and freely convected, thus to bring about an inferior heat-dissipation effect. Furthermore, because the road lamp is not a closed structure, the dust entering through the peripheral gas holes is easily accumulated on the heat-dissipation fins of the heat-dissipation elements, thus to bring about the reduction of the heat-dissipation efficiency of the heat-dissipation effect and short circuits caused by the introduced water. Because the outline of the road lamp brings about a large wind resistance, the strong wind possibly damages the structure of the road lamp. Moreover, the efficiency of the heat-dissipation device is decreased because the heat-dissipation device is disposed in the lamp shade.

Taiwan Patent Publication Number 1320082 discloses a LED road lamp, corresponding to the published U.S. Pat. No. 7,878,691, including a heat dissipater module and a fully-sealed power supply. The heat dissipater module is modulized and assembled by circuit boards, LED chips and a heat-dissipation fin seat. The heat-dissipation fin seat is directly served as an outer shade of the road lamp to contact the atmosphere space for heat dissipation, and the heat generated from the LED chips and the circuit boards is directly transferred to a vertical pipe, thereby achieving a double heat-dissipation effect.

However, '082 case still has the difficulties to be overcome as follows. First, because the road lamp has a box-shaped device which is not streamlined and provides a large section therein, the fluid located on the top portion of the road lamp cannot be smoothly and freely convected, thus to bring about an inferior heat-dissipation effect. Furthermore, because the heat-dissipation fin seat is located at the top of the outer shade where has a low air fluidity, the entering dust is easily accumulated on the heat-dissipation fins of the heat-dissipation elements, thus to bring about the reduction of the heat-dissipation effect. Moreover, because the outline of the road lamp brings about a large wind resistance, the strong wind possibly damages the structure of the road lamp.

Taiwan New Model Patent Publication Number M356839 discloses a LED road lamp, including an outer housing, a LED module and a heat-dissipation module. The LED module and the heat-dissipation module are disposed in the outer housing, and the heat-dissipation module contacted with the LED module is utilized to dissipate the heat generated from the LEDs.

However, '839 case still has the difficulties to be overcome as follows. First, because the design of the heat-dissipation gas holes located at the bottom of the outer housing cannot provide a natural convection flow filed, the heat-dissipation effect of the LED road lamp is imperfect. Furthermore, the water is easily to enter into the LED road lamp through the lateral gas holes, thus to bring about the inner circuit shorts. Moreover, because the outline of the road lamp brings about a large wind resistance, the strong wind possibly damages the structure of the road lamp.

Therefore, it is required to overcome the difficulties of the road lamps disclosed in the above-described cases, such as low air convection, large wind resistance to the road lamp, imperfect heat-dissipation effect, dust accumulation on the heat-dissipation device or short circuits caused by the introduced water.

### BRIEF SUMMARY OF THE INVENTION

In view of this, the present invention provides a light-emitting diode road lamp structure to overcome the difficulties in the cited cases. According to a first aspect, the light-emitting diode road lamp structure comprises a seat body, a circuit unit and a plurality of light-emitting diode lamp tubes. The seat body comprises an accommodation space. The circuit unit accommodated in the accommodation space of the seat body comprises at least two sets of conductive terminals, wherein each of the two sets of conductive terminals comprises a first electrode end and a second electrode end. Each of the light-emitting diode lamp tubes comprises a first conductive end electrically connected to the first electrode end and a second conductive end electrically connected to the second electrode end, such that the light-emitting diode lamp tubes are juxtaposedly disposed outside the seat body and an interspace is formed between each of the light-emitting diode lamp tubes and the light-emitting diode lamp tube abutted therewith.

The light-emitting diode lamp tube has a U shape, an L shape, or a U-like shape.

The seat body further comprises a plurality of openings communicating with the accommodation space, the conductive terminals of the circuit unit are located at the openings of the seat body, and the light-emitting diode lamp tubes are correspondingly penetrated through the openings of the seat body to electrically connect to the conductive terminals of the circuit unit.

The seat body further comprises an upper seat body and a lower seat body corresponding to the upper seat body, and the accommodation space and the openings are formed by assembling the upper seat body and the lower seat body.

Each light-emitting diode lamp tube further comprises a light-tight lamp seat and a light-transmissive lamp shade corresponding to the light-tight lamp seat.

Each light-emitting diode lamp tube is in the form of an arc semi tubular shape.

The light-emitting diode lamp tubes are juxtaposedly configured in the form of a streamline shape.

According to a second aspect, the present invention further provides a light-emitting diode road lamp structure, comprising a seat body and a plurality of tube bodies. The seat body comprises an accommodation space to accommodate a circuit unit. The tube bodies are juxtaposedly connected to an outside of the seat body, and an interspace is formed between each of the tube bodies and the tube body abutted therewith, and a plurality of light-emitting units are accommodated in the tube bodies and electrically connected to the circuit unit.

The seat body further comprises an upper seat body and a lower seat body corresponding to the upper seat body, the tube body comprises a light-tight lamp seat and a light-transmissive lamp shade corresponding to the light-tight lamp seat, the upper seat body of the seat body is connected to the light-tight lamp seat, and the lower seat body of the seat body is connected to the light-transmissive lamp shade.

Each tube body is in the form of an arc semi tubular shape.

The tube bodies are juxtaposedly configured in the form of a streamline shape.

Each tube body has a U shape, an L shape, or a U-like shape.

The present invention provides the functions and effects as follows.

First, the road lamp structure can smoothly guide the air flow and provide excellent heat-dissipation efficiency, thereby remaining the LED units at a lower working temperature to keep the luminous efficiency and extending the life span of the LED units. Further, because the LED units have excellent heat-dissipation efficiency, the LED road lamp can be designed in a closed type, thereby avoiding the rain or dust entering the inside of the LED road lamp to bring about the short circuits. Because the air flow can smoothly pass through the road lamp, the wind resistance of the road lamp can be reduced and the damages of the road lamp caused by the strong wind can be prevented. Further, with the rounded surface of the lamp tubes, the dust approaching the rounded lamp tubes can be quickly carried away by the air flow, thus to prevent the reduction of the lamp tubes caused by the accumulated dust. In addition, the optical luminance uniformity of the road lamp can be normally remained, and the heat-dissipation effect of the road lamp can be achieved without additional heat-dissipation device.

A detailed description is given in the following embodiments with reference to the accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present invention can be more fully understood by reading the subsequent detailed description and examples with references made to the accompanying drawings, wherein:

FIG. 1 is an exploded view according to a preferred embodiment of the present invention;

FIG. 2 is a perspective view according to the preferred embodiment of the present invention;

FIG. 3 is a schematic view according to another embodiment of the present invention;

FIG. 4 is a schematic view illustrating another arrangement of lamp tubes or tube bodies of the preferred embodiment of the present invention;

FIG. 5 is a schematic view illustrating another arrangement of lamp tubes or tube bodies of the preferred embodiment of the present invention;

FIG. 6 schematically and comparatively shows that testing diagrams of the air flow fluency degree of a road lamp of the present invention and a dish-shaped road lamp;

FIG. 7 schematically and comparatively shows that testing diagrams of the air flow fluency degree of a road lamp of the present invention and a dish-shaped road lamp;

FIG. 8 schematically and comparatively shows that testing diagrams of the generated temperature distribution of a road lamp of the present invention and a dish-shaped road lamp;

FIG. 9 schematically and comparatively shows that testing diagrams of the wind resistance stress analysis of a road lamp of the present invention and a dish-shaped road lamp;

FIG. 10 schematically and comparatively shows that testing diagrams of the luminance uniformity of a road lamp of the present invention, a dish-shaped road lamp and a single light-emitting diode (LED) road lamp;

FIG. 11 is a relationship diagram of the junction temperature and the luminous efficiency of a light-emitting diode (LED); and

FIG. 12 is a relationship diagram of the operation temperature and the life span of a light-emitting diode (LED).

### DETAILED DESCRIPTION OF THE INVENTION

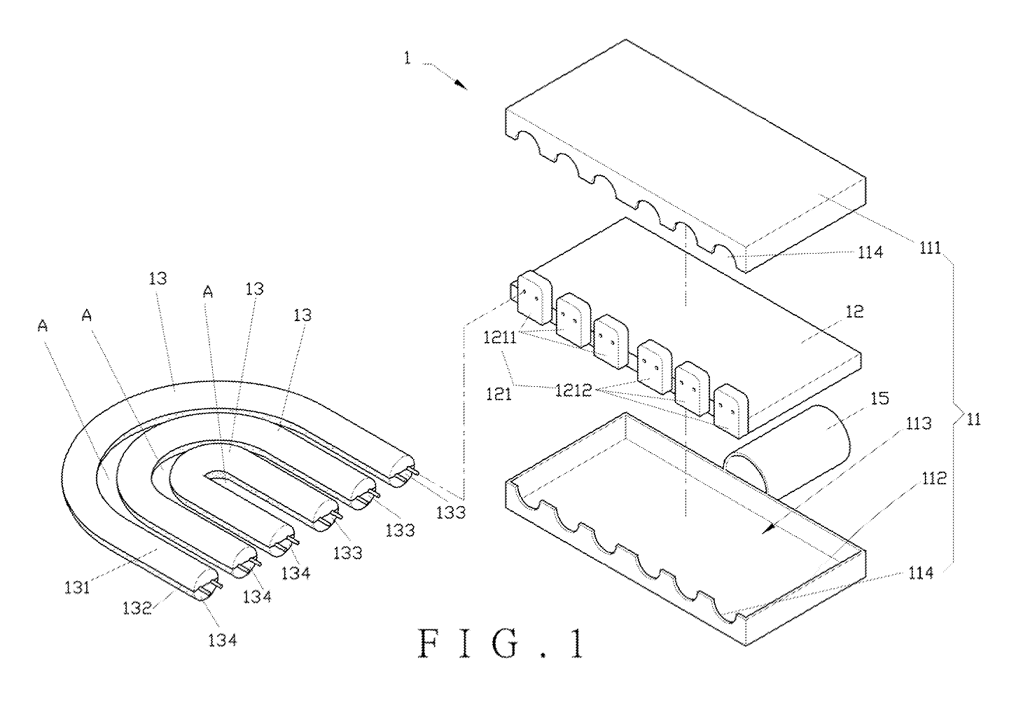

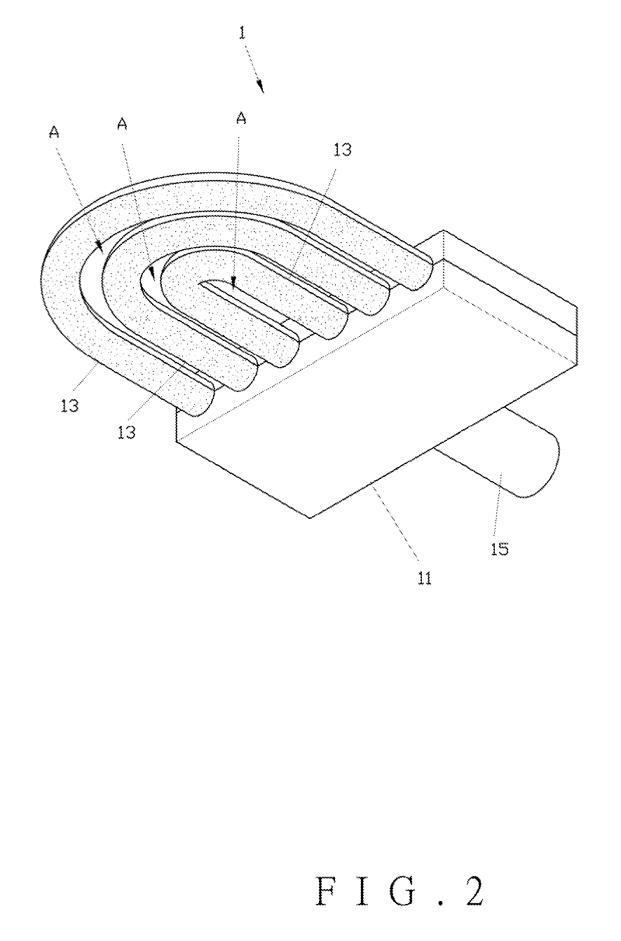

Referring to FIGS. 1 and 2, the light-emitting diode (LED) road lamp 1 according to a preferred embodiment of the present invention comprises a seat body 11, a circuit unit 12 and a plurality of light-emitting diode (LED) lamp tubes 13.

The seat body 11 comprises an upper seat body 111, a lower seat body 112 corresponding to the upper seat body 111, an accommodation space 113 defined between the upper seat body 111 and the lower seat body 112, and a plurality of openings 114 communicating with the accommodation space 113. A lamp-post head 15 is connected to one end of the seat body 11 opposite to the openings 114. The lamp-post head 15 is further connected to a lamp post (not shown in drawings).

The circuit unit 12 is a LED driving circuit component accommodated in the accommodation space 113. The circuit unit 12 comprises at least two sets of conductive terminals 121, and each set of which comprises a first electrode end 1211 and a second electrode end 1212. The first electrode end 1211 and the second electrode end 1212 of each set of conductive terminal 121 are located at the openings 114, respectively.

Each LED lamp tube 13 is in the form of an arc semi-tubular shape, such as a U shape. Each LED lamp tube 13 comprises a light-tight lamp seat 131 and a light-transmissive lamp shade 132 corresponding to the light-tight lamp seat 131, wherein a plurality of LED units (not shown in drawings) are disposed between the light-tight lamp seat 131 and the light-transmissive lamp shade 132. Each LED lamp tube 13 further comprises a first conductive end 133 and a second conductive end 134 at two ends thereof to electrically connect to the LED units, wherein the first conductive end 133 is electrically connected to the first electrode end 1211, and the second conductive end 134 is electrically connected to the second electrode end 1212.

The LED lamp tubes 13 are correspondingly penetrated through the openings 114 of the seat body 11 to electrically connect the first conductive ends 133 and the second conductive ends 134 to the first electrode ends 1211 and the second electrode ends 1212 of the circuit unit 12, respectively. The LED lamp tubes 13 are juxtaposedly disposed outside the seat body 11 and an interspace ‘A’ is formed between each of the LED lamp tubes 13 and the LED lamp tube 13 abutted therewith, thereby providing a configuration in the form of a streamline shape.

With the streamlined interspaces ‘A’ formed between the adjacent LED lamp tubes 13, the air flow passing through the LED lamp tubes 13 can be facilitated, and therefore some following features and advantages can be obtained.

First, the heat generated from the LED lamp tubes 13 can be efficiently carried away by the air flow passing through the streamlined interspaces ‘A’ therebetween, thereby reducing the operation temperature of the LED lamp tubes 13, maintaining the luminous efficiency of the LED lamp tubes 13, and extending the life span of the LED lamp tubes 13. Because the air flow is allowed to pass through the LED road lamp structure 1, the wind resistance acting on the LED road lamp structure 1 can be reduced, and the LED road lamp structure 1 damaged by the strong winds can be possibly prevented. Further, due to the LED lamp tubes 13 having excellent heat-dissipation efficiency, the LED road lamp structure 1 can be designed in a closed type, capable of avoiding the rain or dust entering the inside of the LED road lamp structure 1 and reducing the failure rate. In addition, the dust approaching the LED road lamp structure 1 can be possibly carried away by the air flow while passing through the LED road lamp structure 1, i.e., the reduction of the heat-dissipation efficiency of the LED road lamp structure 1 caused by the dust accumulated thereon can be eliminated.

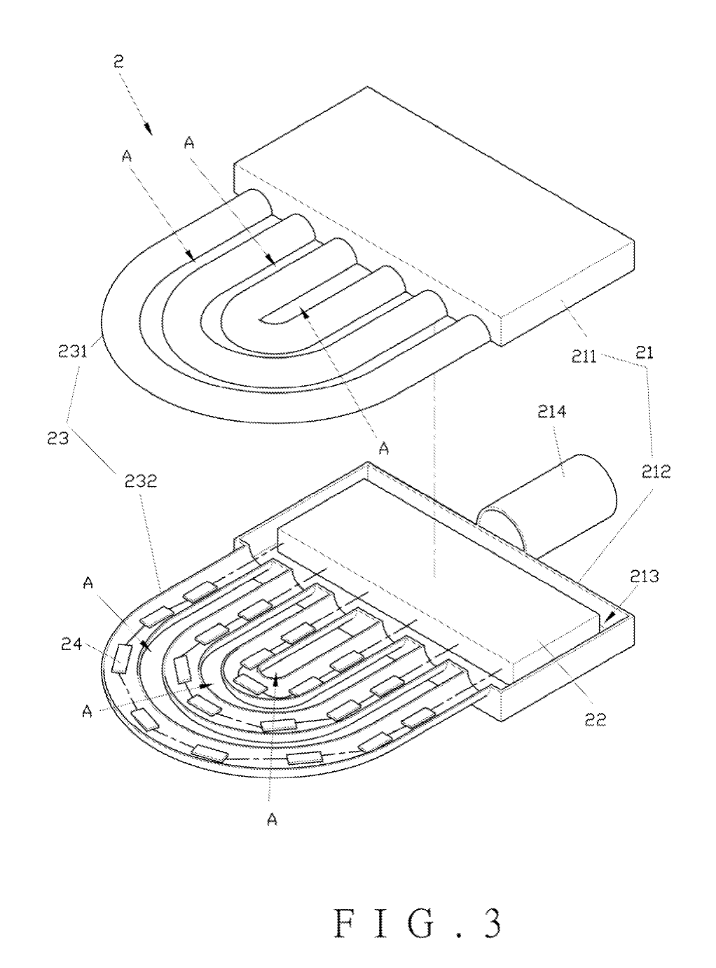

Referring to FIG. 3, another embodiment of a road lamp of the present invention is illustrated. A light-emitting diode (LED) road lamp structure 2 of the present invention comprises a seat body 21 and a plurality of tube bodies 23.

The seat body 21 comprises an upper seat body 211 and a lower seat body 212 corresponding to the upper seat body 211, wherein the upper seat body 211 and the lower seat body 212 are assembled to each other to form an accommodation space 213 which is utilized to accommodate a circuit unit 22 therein. In this embodiment, the circuit unit 22 is a LED driving circuit component. The seat body 21 is connected to a lamp-post head 214. The lamp-post head 214 is further connected to a lamp post (not shown in drawings).

Each tube body is in the form of an arc semi-tubular shape, such as a U shape. Each tube body 23 comprises a light-tight lamp seat 231 and a light-transmissive lamp shade 232 corresponding to the light-tight lamp seat 231, wherein the light-tight lamp seat 231 is connected to the upper seat body 211 of the seat body 21, and the light-transmissive lamp shade 232 is connected to the lower seat body 212 of the seat body 21. A plurality of light-emitting units 24 accommodated in the tube bodies 23 are electrically connected to the circuit unit 22. The tube bodies 23 are juxtaposedly connected to an outside of the seat body 21 and an interspace ‘A’ is formed between each of the tube bodies 23 and the tube body 23 abutted therewith, thereby providing a configuration in the form of a streamline shape and the same effects of the above-described embodiment as shown in FIGS. 1 and 2.

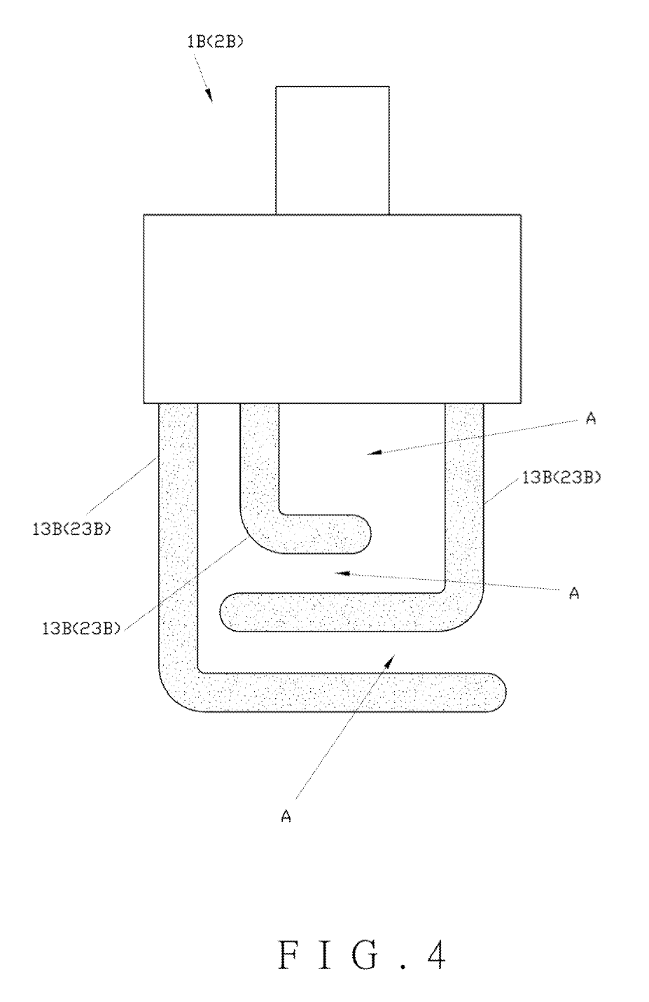

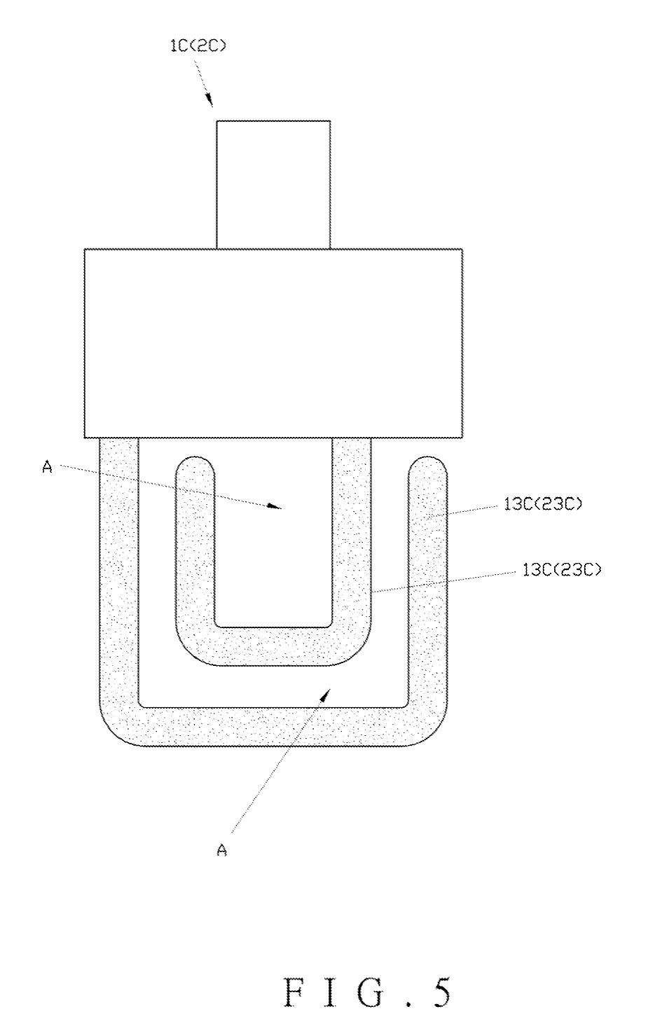

It is noted that the main technical feature of the road lamp of the present invention includes the interspace ‘A’ formed therewith, and therefore it is understood that the invention is not limited to the configuration and the juxtaposition of the LED lamp tubes 13 or the tube bodies 23. The above-described results of the embodiments can be achieved only if the interspace ‘A’ can be formed in the road lamp. Referring to FIG. 4, another type of a road lamp structure 1B, 2B is illustrated. In the road lamp structure 1B, 2B, LED lamp tubes 13B or tube bodies 23B have an L shape, and interspaces ‘A’ formed therein can have the same results as the above-described embodiments. Referring to FIG. 5, another type of a road lamp structure 1C, 2C is illustrated. In the road lamp structure 1C, 2C, LED lamp tubes 13C or tube bodies 23C have a U-like shape, and interspaces ‘A’ formed therein can have the same results as the above-described embodiments.

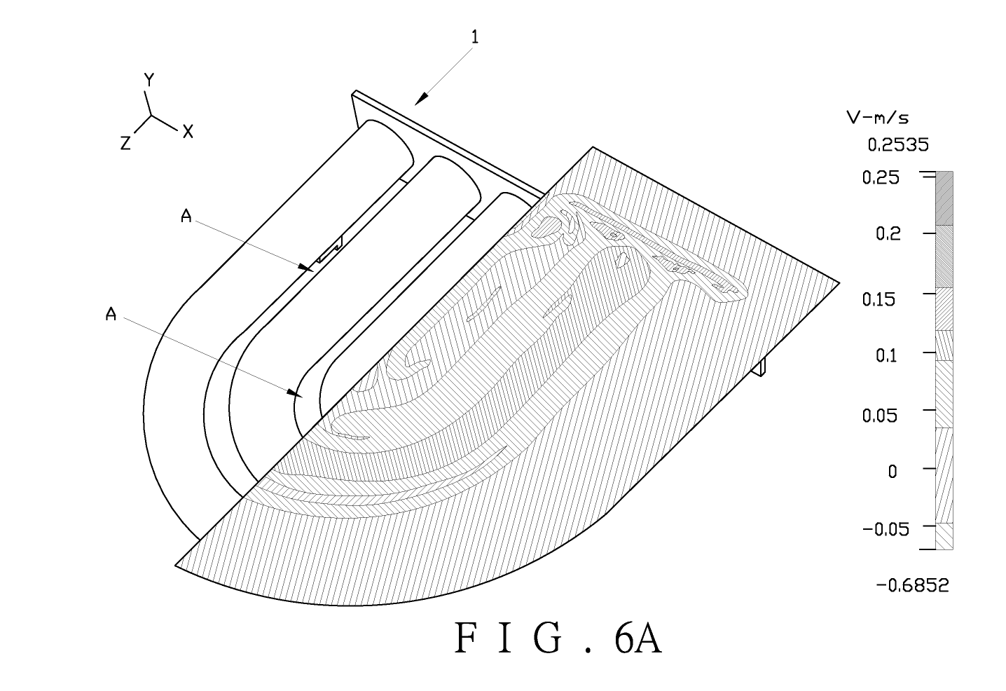

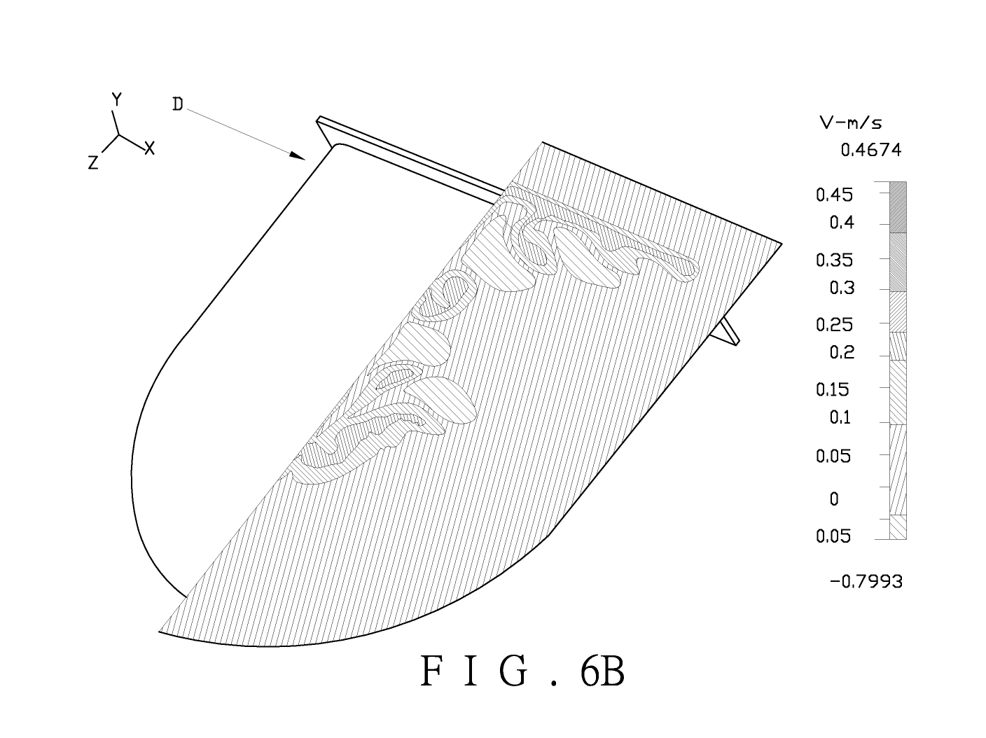

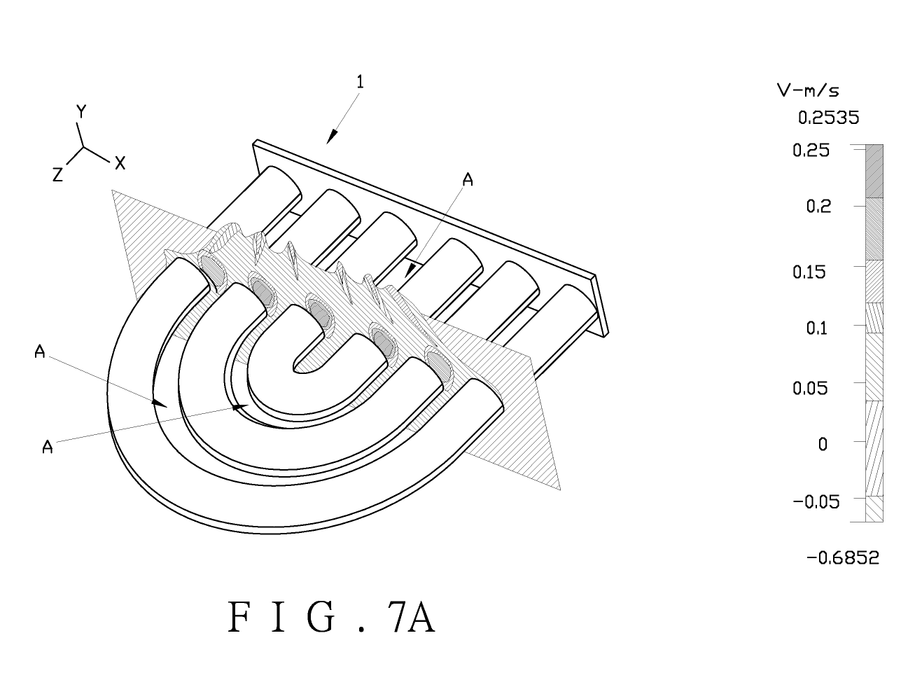

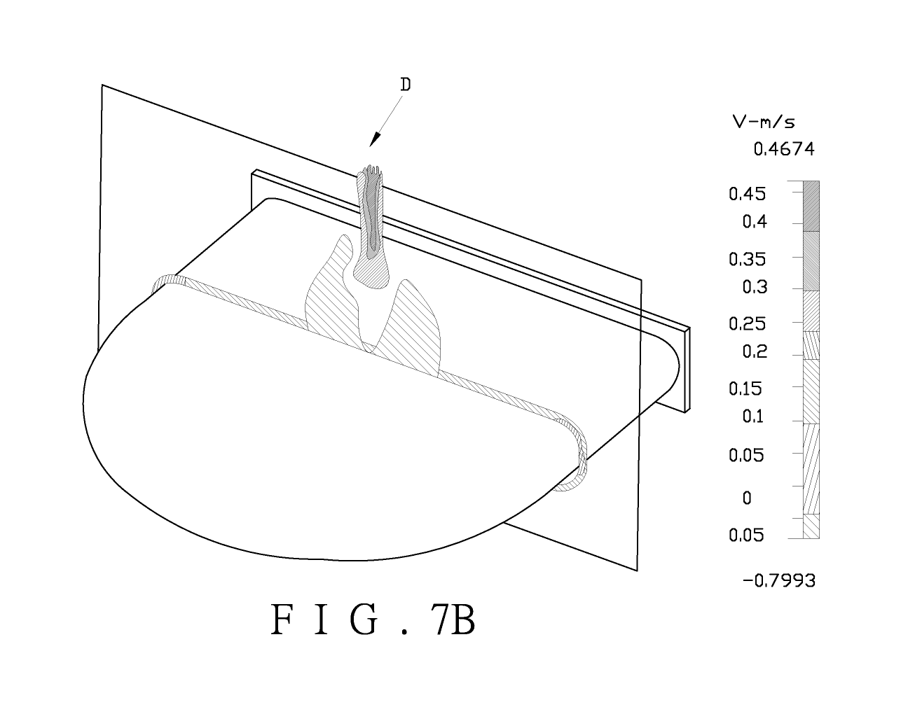

Referring to FIG. 6, testing diagrams of the air flow fluency degree of the road lamp structure 1 of the present invention and a dish-shaped road lamp structure ‘D’ are comparatively presented. Taking power of 80 watt for the road lamp structure 1 and the dish-shaped road lamp structure ‘D’ for example, assumed that 70% of this power produces heat energy uniformly distributed on the road lamp structure 1 and the dish-shaped road lamp structure ‘D’ and the testing is performed on the condition of a reduced net grid by omitting the seat body 11, it is known that, from a section measured at five centimeters above the horizontal middle line with respect to the road lamp structure 1 and the dish-shaped road lamp structure ‘D’, a Y-direction velocity of the road lamp structure 1 has a positive value resulting from the interspace ‘A’, i.e., it represents that the road lamp structure 1 is provided with the air flow smoothly traveling from the bottom upward; meanwhile, the dish-shaped road lamp structure ‘D’ has a chaotic flow field provided with upward and downward air flows affecting the heat dissipation effect. Referring to FIG. 7, schematic sections of the flow fields of the road lamp structure 1 and the dish-shaped road lamp structure ‘D’ are comparatively presented. It can be observed that the condition in FIG. 7 is similar to that in FIG. 6.

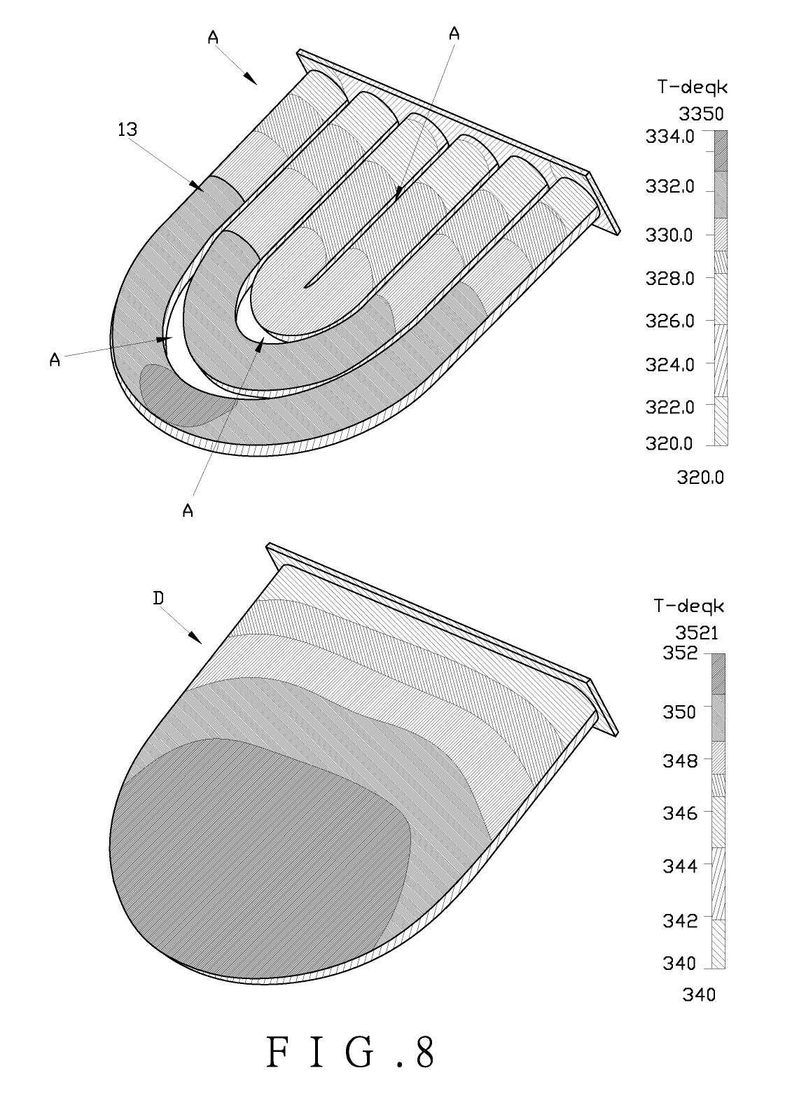

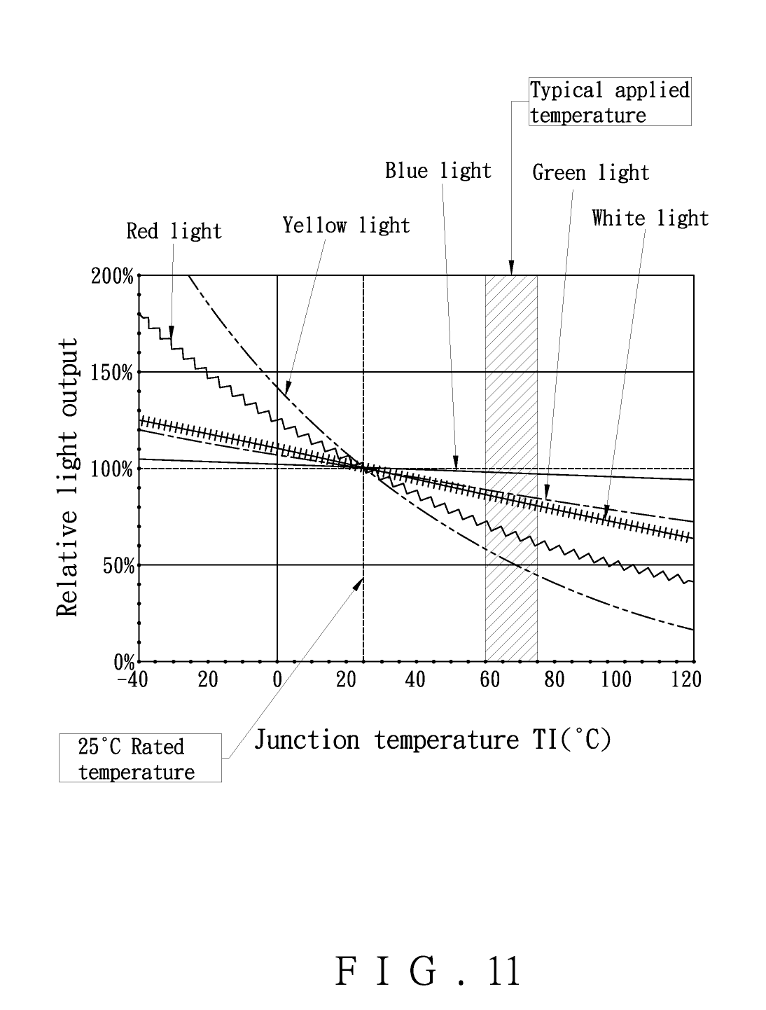

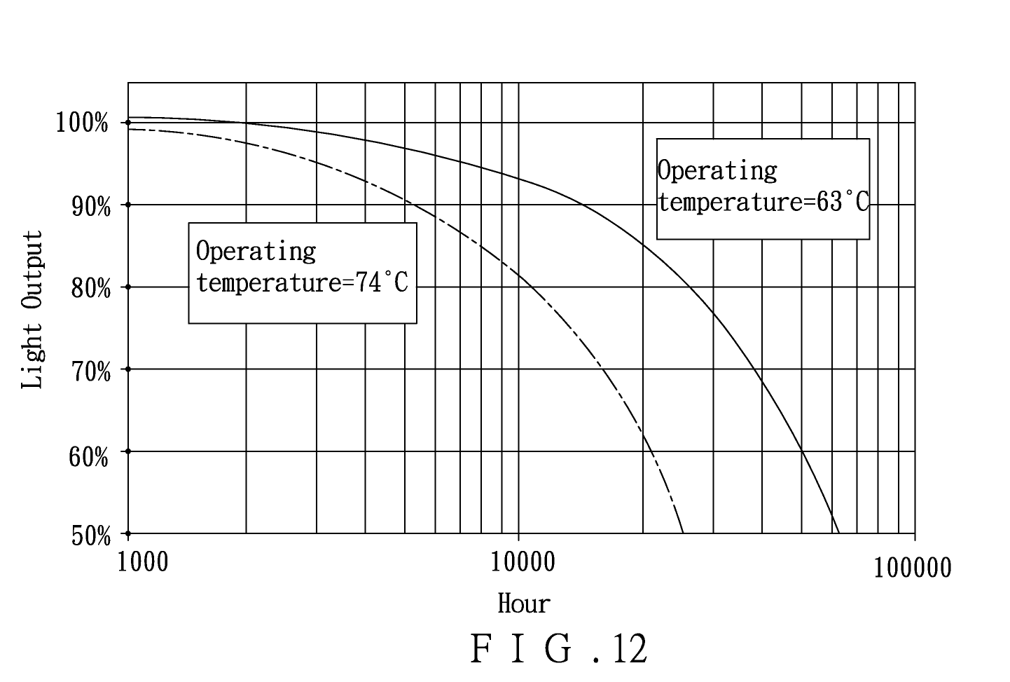

Referring to FIG. 8, testing diagrams of the generated temperature distribution of the flow fields of the road lamp structure 1 and the dish-shaped road lamp structure ‘D’ are comparatively presented. In FIG. 8, it is clearly seen that the highest temperature of the road lamp structure 1 is about 335° K (about 62° C.), and the highest temperature of the dish-shaped road lamp structure ‘D’ is about 352° K (about 79° C.). It is known that the air flow is allowed to pass through the LED road lamp structure 1 via the interspaces ‘A’ formed between the adjacent LED lamp tubes 13, thus to provide the LED road lamp structure 1 with excellent heat-dissipation efficiency. Further, in accordance with FIGS. 11 and 12, the highest temperature of the road lamp structure 1 is maintained less than about 335° K, thus to keep the luminous efficiency and to extend the life span of the LED lamp tubes 13.

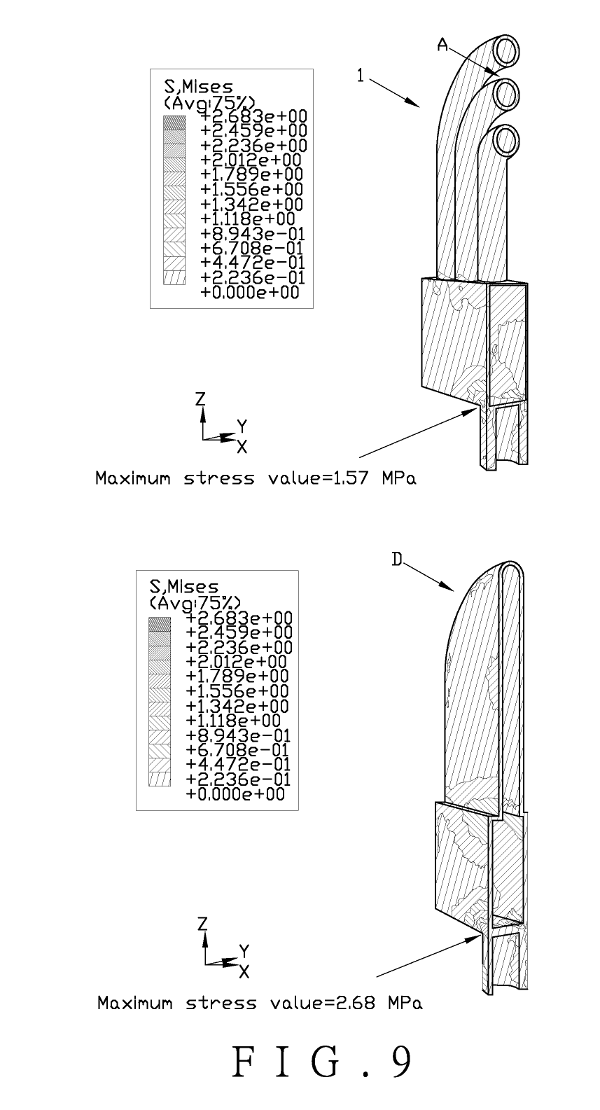

Referring to FIG. 9, testing diagrams of the wind resistance stress analysis of the road lamp structure 1 and the dish-shaped road lamp structure ‘D’ are comparatively presented. It is assumed that the testing process is performed at 20 m/sec of wind speed, and the road lamp structure 1 has a maximum Von Mises stress of 1.57 MPa and the dish-shaped road lamp structure ‘D’ has a maximum Von Mises stress of 2.68 MPa. It may be known that the air flow is allowed to pass through the LED road lamp structure 1, the wind resistance acting on the LED road lamp structure 1 is less than that of the dish-shaped road lamp structure CD', and therefore the LED road lamp structure 1 can suffer strong winds without being damaged.

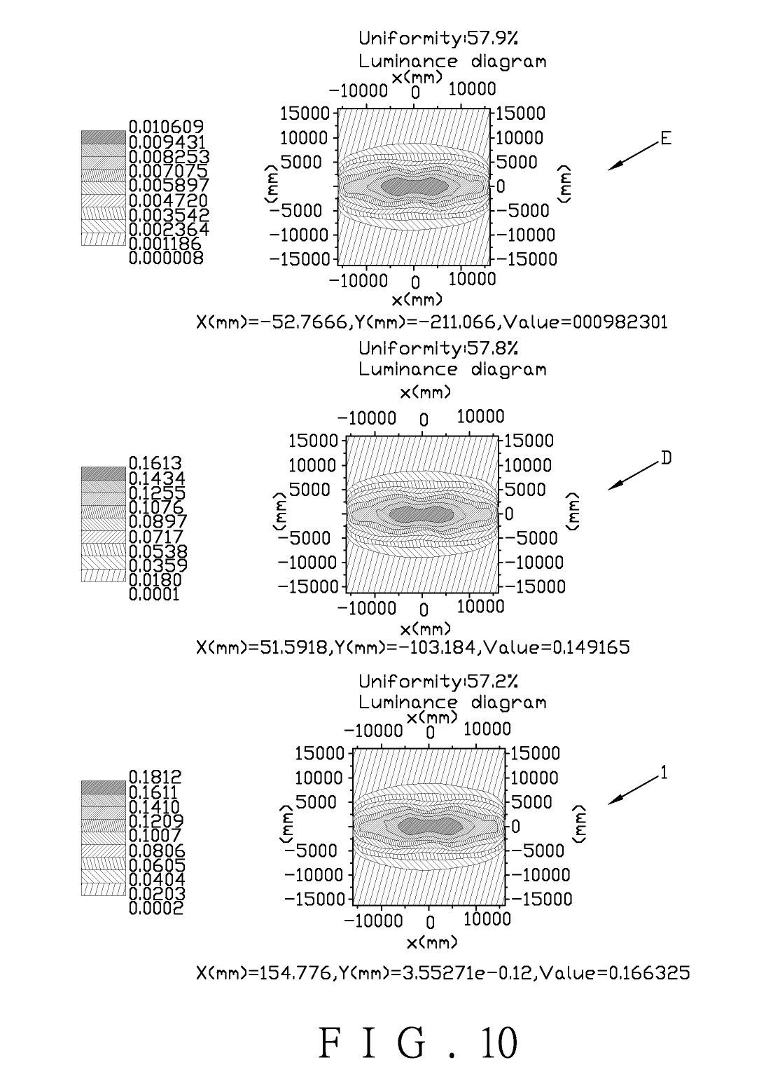

According to the illumination regulations, the luminance uniformity of different road surfaces shall be greater than 0.4 (40%). Referring to FIG. 10, testing diagrams of the luminance uniformity of the road lamp structure 1, the dish-shaped road lamp structure ‘D’ and a single LED road lamp structure ‘E’ are comparatively presented, wherein the luminance uniformities of the road lamp structure 1, the dish-shaped road lamp structure ‘D’ and the single LED road lamp structure ‘E’ are 57.2%, 57.9% and 57.8%, which all meet the illumination regulations. Thus, it is known that the design of road lamp structure 1 of the present invention meets the regulations of the luminance uniformity.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A light-emitting diode road lamp structure, comprising:
a seat body comprising an accommodation space;
a circuit unit accommodated in the accommodation space of the seat body, comprising at least two sets of conductive terminals, each of the two sets of conductive terminals comprising a first electrode end and a second electrode end; and
a plurality of light-emitting diode lamp tubes, each of the light-emitting diode lamp tubes comprising a first conductive end electrically connected to the first electrode end and a second conductive end electrically connected to the second electrode end, such that the light-emitting diode lamp tubes are juxtaposedly disposed outside the seat body and an interspace is formed between each of the light-emitting diode lamp tubes and the light-emitting diode lamp tube abutted therewith.

2. The light-emitting diode road lamp structure as claimed in claim 1, wherein the plurality of light-emitting diode lamp tubes each have a U shape.

3. The light-emitting diode road lamp structure as claimed in claim 1, wherein the plurality of light-emitting diode lamp tubes each have an L shape.

4. The light-emitting diode road lamp structure as claimed in claim 1, wherein the plurality of light-emitting diode lamp tubes each have a U-like shape.

5. The light-emitting diode road lamp structure as claimed in claim 1, wherein the seat body further has a plurality of openings communicating with the accommodation space, the conductive terminals of the circuit unit are located at the openings of the seat body, and the light-emitting diode lamp tubes are correspondingly penetrated through the openings of the seat body to electrically connect to the conductive terminals of the circuit unit.

6. The light-emitting diode road lamp structure as claimed in claim 5, wherein the seat body further comprises an upper seat body and a lower seat body corresponding to the upper seat body, and the accommodation space and the openings are formed by assembling the upper seat body and the lower seat body.

7. The light-emitting diode road lamp structure as claimed in claim 1, wherein the plurality of light-emitting diode lamp tubes each further comprises a light-tight lamp seat and a light-transmissive lamp shade corresponding to the light-tight lamp seat.

8. The light-emitting diode road lamp structure as claimed in claim 1, wherein the plurality of light-emitting diode lamp tubes each is in the form of an arc semi-tubular shape.

9. The light-emitting diode road lamp structure as claimed in claim 1, wherein the light-emitting diode lamp tubes are juxtaposedly configured in the form of a streamline shape.

10. A light-emitting diode road lamp structure, comprising:
a seat body comprising an accommodation space to accommodate a circuit unit; and
a plurality of tube bodies juxtaposedly connected to an outside of the seat body, an interspace formed between each of the tube bodies and the tube body abutted therewith, a plurality of light-emitting units accommodated in the tube bodies and electrically connected to the circuit unit.

11. The light-emitting diode road lamp structure as claimed in claim 10, wherein the seat body further comprises an upper seat body and a lower seat body corresponding to the upper seat body, the plurality of tube bodies each comprises a light-tight lamp seat and a light-transmissive lamp shade corresponding to the light-tight lamp seat, the upper seat body of the seat body is connected to the light-tight lamp seat, and the lower seat body of the seat body is connected to the light-transmissive lamp shade.

12. The light-emitting diode road lamp structure as claimed in claim 10, wherein the plurality of tube bodies each is in the form of an arc semi-tubular shape.

13. The light-emitting diode road lamp structure as claimed in claim 10, wherein the tube bodies are juxtaposedly configured in the form of a streamline shape.

14. The light-emitting diode road lamp structure as claimed in claim 10, wherein the plurality of tube bodies each have a U shape.

15. The light-emitting diode road lamp structure as claimed in claim 10, wherein the plurality of tube bodies each have an L shape.

16. The light-emitting diode road lamp structure as claimed in claim 10, wherein the plurality of tube bodies each have a U-like shape.
